(19) United States
(12) Patent Application Publication
(10) Pub. No.: US 2002/0144572 A1
(43) Pub. Date: Oct. 10, 2002

(54) Sewer cap prying blade

(76) Inventor: Kevin M. Chaves, E. Taunton, MA (US)

Correspondence Address: John P. McGonagle, Law Offices of John P. McGonagle, 800 Hingham Street - 2N, Rockland, MA, 02370, US

(21) Appl. No.: 09/826,152

(22) Filed: Apr. 5, 2001

(51) Int. Cl. B67B 7/16

(52) U.S. Cl. 81/3.55

(57) ABSTRACT

A tool comprised of an elongated handle with a shaped pry bar blade attached thereto. The pry bar blade has a semicircular opening formed therein with a radius approximately equal to the radius of the sewer pipe. The pry blade is fitted about the neck of the plug or cap. Manipulation of the handle quickly pries the plug or cap from the sewer pipe. A worker may use the present invention without climbing into the sewer line trench.

### BACKGROUND OF THE INVENTION

This invention relates to prying blades, and in particular, to a tool for easily removing a plastic cap or plug from a sewer pipe or any other system with pipes having caps or plugs.

In the development of residential housing or tying in established housing to new sewer lines, it is the practice to initially install a main sewer line extending along the length of the street. The pipe includes a separate lateral pipe or extension for each lot adjacent the street. The lateral pipe is initially closed by a sealing device and buried five to ten feet beneath ground level. As individual houses are constructed, a sewer line from the new home is typically also closed by a sealing device to await connection to the main sewer line lateral pipe. Such sealing is typically done by means of a polyvinyl chloride (PVC) plastic plug or cap which is used to seal the sewer line. The plug or cap usually will have an O-ring seal to have the pipe sealingly engage the plug or cap.

At a later time, a plumber or sewer contractor must remove the plug or cap to accomplish hook-up to the main sewer line. The plug or cap, being tightly fit into the pipe, is usually difficult to remove with known tools in the art. In addition to the tight fit there is usually a great deal of internal pipe pressure creating a suction holding the plug or cap in the pipe. Such difficulty in removal often results in damage to the sewer pipe itself when tools such as crow bars, pry bars, hammers and chisels are used to remove the pipe plug.

Removal of a plug or cap is also time consuming with prior art devices, usually taking 10 to 15 minutes to remove a plug or cap. The problem is compounded by the fact that sewer tie-ins are usually found in trenches to a depth of 8 feet, requiring a worker to climb into the trench and then manipulate the cap or plug from the pipe. There is a danger to working in a trench which is subject to collapse during construction.

Attempts have been made in the prior art to solve the problems of removing plugs and caps from sewer lines. Most notably have been U.S. Pat. Nos. 5,003,682 to D. I. Strausbaugh, et al.; 4,786,214 to E. M. Schmidt, et al.; and 4,691,424 to E. M. Schmidt, et al. These patents disclose pulling devices which are attached to a sewer pipe plug or cap and manipulated to remove the plug or cap. However, these prior art devices require a worker to climb into the sewer pipe trench, attach the patented device and manipulate the device to remove the plug or cap. The patented devices or the prior art are complex, and time consuming to attach, manipulate and remove. During this operation the worker is in continuous danger of trench collapse.

### SUMMARY OF THE INVENTION

The present invention addresses the limitations of prior art devices by providing a tool which is comprised of an elongated handle with a shaped pry bar blade attached thereto. The pry bar blade has a semicircular opening formed therein with a radius approximately equal to the radius of the sewer pipe. The pry blade is fitted about the neck of the plug or cap. Manipulation of the handle quickly pries the plug or cap from the sewer pipe. A worker may use the present invention without climbing into a sewer line trench.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1A is a side elevational view of a sewer pipe end with a plug installed therein.

FIG. 1B is a side elevational view of the end of another type sewer pipe with a plug or cap installed therein.

FIG. 2 is a front elevational view of one embodiment of the invention.

FIG. 3 is a diagrammatic view of the invention view shown in FIG. 2.

FIG. 4 is a bottom view of the invention embodiment shown in FIG. 3.

FIG. 5 is a detail view, partly in section, of the invention view shown in FIG. 4.

FIG. 6 is a diagrammatic view of the invention handle.

FIG. 7 is a diagrammatic view of the rubber handle portion of the invention.

FIG. 8 is a front elevational view of another embodiment of the invention.

FIG. 9 is a side elevational view the invention view shown in FIG. 10.

FIG. 10 is a diagrammatic view of the invention view shown in FIG. 8.

FIG. 11 is a bottom view of the invention embodiment shown in FIG. 10.

FIG. 12 is a detail view, partly in section, of the invention view shown in FIG. 11.

FIG. 13 is a front elevational view of still another embodiment of the invention.

FIG. 14 is a sectional view along the line 14-14 of FIG. 13.

FIG. 15 is a side elevational view of the invention embodiment shown in FIG. 13 FIG. 16 is a section view along the line 16-16 of FIG. 15.

FIG. 17 is a front elevational view of still another embodiment of the invention.

FIG. 18 is a sectional view along the line 18-18 of FIG. 17.

FIG. 19 is a side elevational view of the invention embodiment shown in FIG. 17.

### DETAILED DESCRIPTION OF INVENTION

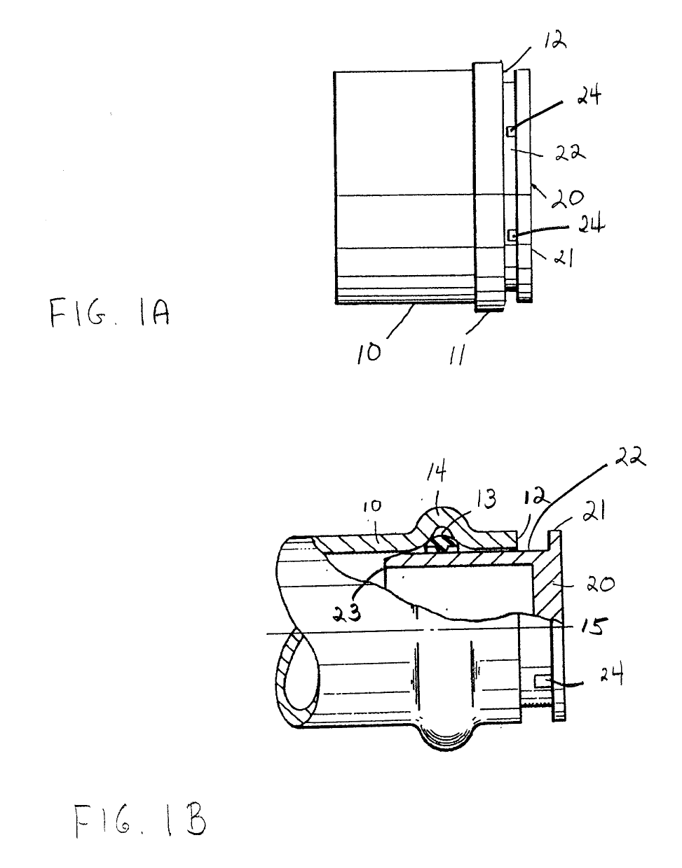

Referring to the drawings in detail wherein like elements are indicated by like numerals, there is shown in FIG. 1A an end portion of a sewer lateral pipe 10 supported by a gasket housing 11. A plug 20 to seal the pipe end portion 10 has a lid 21 and a body portion 22. FIG. 1B illustrates an alternate sewer lateral pipe 10 having a cylindrical main body with an open end 12. The open end 12 is removably closed by an end plug 20. The end plug 20 is sized to fit sealingly within the pipe 10 and being engaged by a conventional O-ring seal 13 fixedly mounted interiorly within ridge 14, i.e., gasket housing, formed on the main body of the pipe 10. The end plug 20 has a cylindrical main body 22 with a tapered end 23 to facilitate insertion of the end plug 20 into the pipe 10. A flange-shaped lid 21 extends radially outward of and circumferentially around the cylindrical main body 22 of the plug 20. A plurality of projections or stops 24 are integrally formed on the plug 20 and extend from the lid 21 toward the pipe end 12 and are in abutting engagement with the end 12 when the plug 20 is fully mounted to the pipe 10. The pipe 10 and plug 20 have a longitudinal axis 15 extending centrally there through. The pipe 10 and plug 20 shown in FIGS. 1A and 1B are typically produced from polyvinyl chloride (PVC) material and are commercially available.

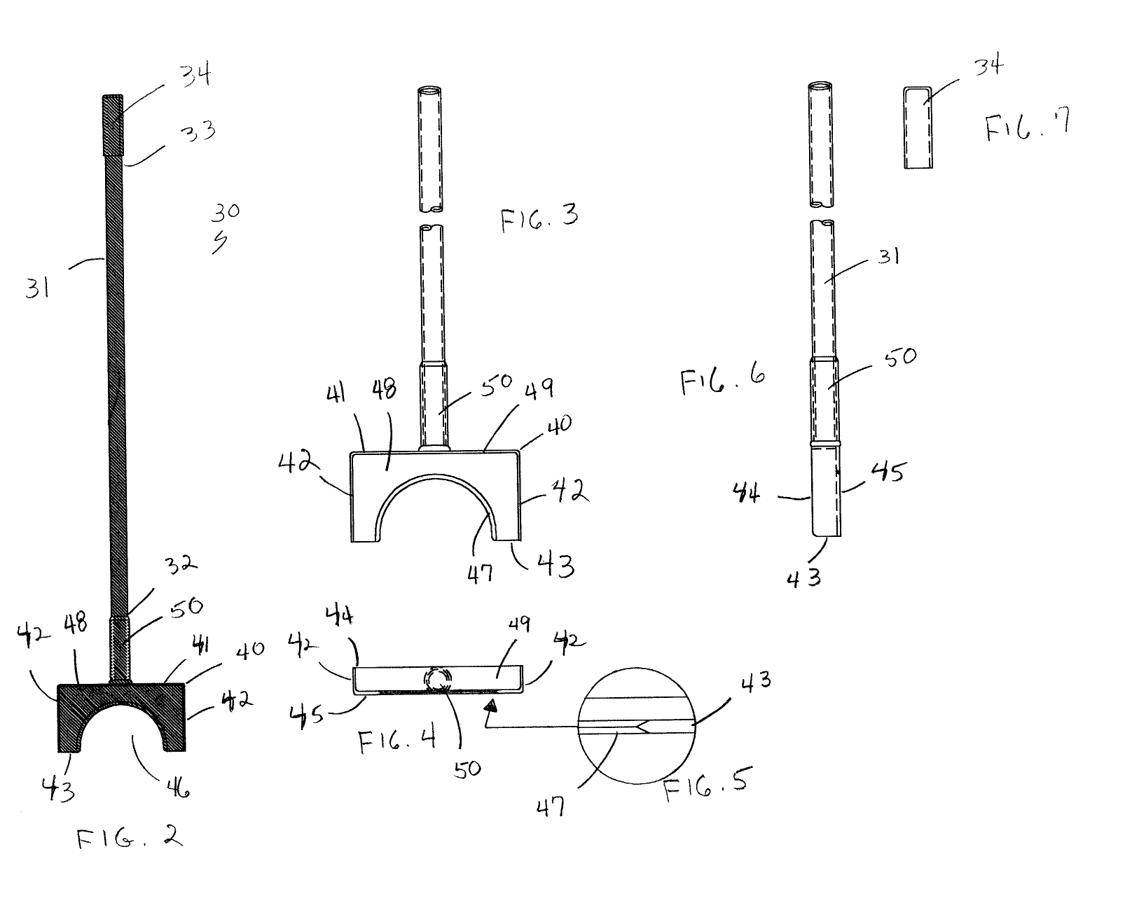

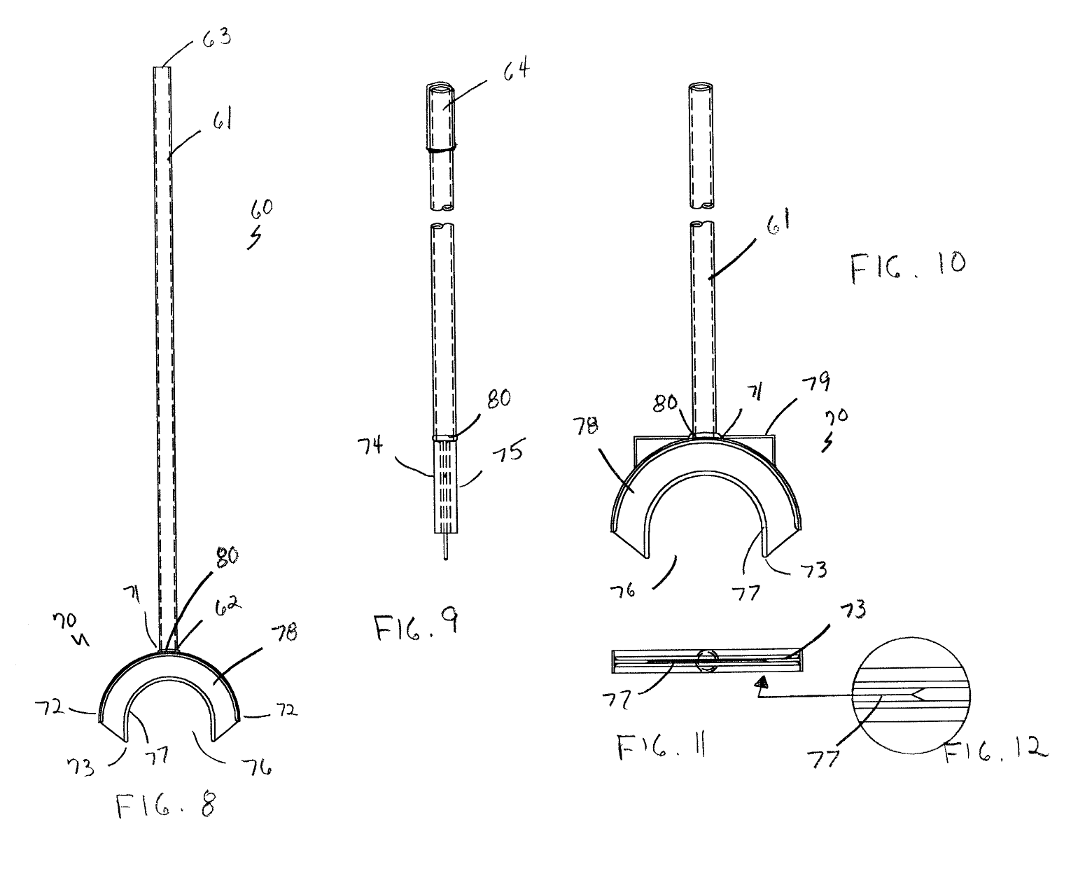

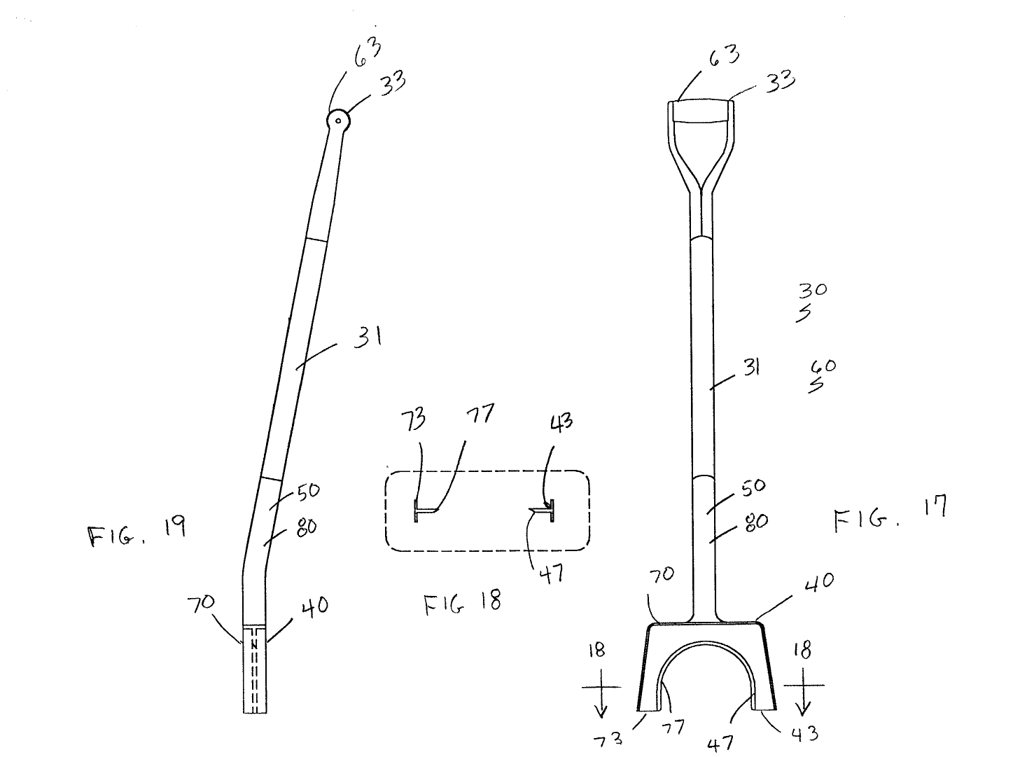

Referring generally to the drawings and particularly to FIGS. 2-7, there is shown a plug prying blade 30 embodiment constructed according to the principles of the invention. The prying blade 30 is comprised of a blade assembly 40 and an elongated handle assembly 31. In this embodiment of the invention, the blade assembly 40, in an upright vertical orientation, has a top 41, two sides 42, a bottom 43, a front 44 and a rear 45. The blade assembly 40 has a generally flat, rectangular, plate-like body 48 with a substantial, semicircular opening 46 formed therein with the diameter of the widest portion of the opening coinciding centrally with the blade assembly bottom 46. The opening 46 has an inwardly directed, sharpened beveled edge 47 formed about the body perimeter. The blade assembly top 41 has a flange 49 welded thereon, said flange 49 lying in a plane perpendicular to the plane of the blade assembly 40. The blade assembly top flange 49 has a hollow, cylindrical collar 50 welded to its center. The collar 50 protrudes perpendicularly away from the flange 49. In this embodiment of the invention, the collar's central, longitudinal axis lies perpendicular to the plane of the flange 49. However, in other embodiments of the invention the collar's central, longitudinal axis may have a different angle orientation with the plane of the flange 49, as shown in FIGS. 13-19.

The handle assembly 31 has a blade assembly end 32 and an opposite free end 33. The handle 31 is a pipe formed with wall steel or fiberglass. The handle blade assembly end 32 is inserted into and attached to the blade assembly top flange, hollow, cylindrical collar 50. A rubber handle section 34 is placed over the handle fee end 33. In alternative embodiments such as shown in FIGS. 13 and 17, the handle free end 33 may be shaped with a conventional, shovel, cross bar grip.

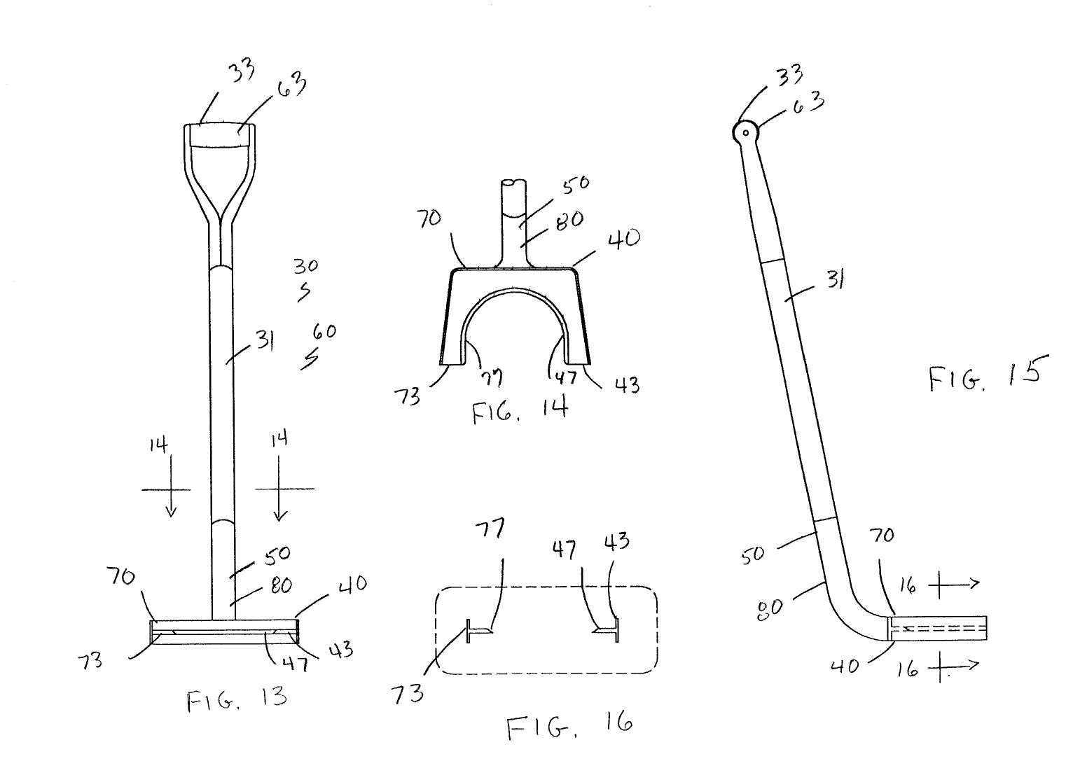

Referring generally to the drawings and particularly to FIGS. 8-12, there is shown another plug or cap prying blade 60 embodiment constructed according to the principles of the invention. The prying blade 60 is comprised of a blade assembly 70 and an elongated handle assembly 61. In this embodiment of the invention, the blade assembly 70, in an upright vertical orientation, has a top 71, two sides 72, a bottom 73, a front 74 and a rear 75. The blade assembly 70 has a generally flat, crescent-shaped, plate-like body 78 with a substantial, semicircular opening 76 formed therein with the diameter of the widest portion of the opening coinciding centrally with the blade assembly bottom 76. The opening 76 has an inwardly directed, sharpened beveled edge 77 formed about the body perimeter. The blade assembly top 71 may have a rectangular, flat-bar flange 79 welded thereon, said flange 79 lying in a plane perpendicular to the plane of the blade assembly 70. The blade assembly top 71 or flange 79 has a hollow, cylindrical collar 80 welded to its center. The collar 80 protrudes perpendicularly away from the top 71 or flange 79. In this embodiment of the invention, the collar's central, longitudinal axis lies perpendicular to the plane of the flange 79. However, in other embodiments of the invention the collar's central, longitudinal axis may have a different angle orientation with the plane of the flange 79, as shown in FIGS. 13-19. The flange 79 provides stiffening to the blade assembly body 78 and provides a means for pushing the blade assembly 70 down with a worker's foot as may be necessary from time to time.

The handle assembly 61 has a blade assembly end 62 and an opposite free end 63. The handle 61 is a pipe formed with wall steel or fiberglass. The handle blade assembly end 62 is inserted into and attached to the blade assembly top flange, hollow, cylindrical collar 80. A rubber handle section 64 is placed over the handle fee end 63. In alternative embodiments, such as shown in FIGS. 13 and 17, the handle free end 63 may be shaped with a conventional, shovel, cross bar grip.

The construction of the tool shown in the drawings includes, but is not limited to, a plurality of ferrous, non-ferrous and thermoplastic materials, that is, aluminum, magnesium, titanium, steel/alloy steel, stainless steel, nylon, and other plastic materials. The design and shape of the tool is such to facilitate use in adverse environment conditions inherent in the employment of the tool including corrosive atmospheres, inclement weather, habitats and normal operational abuse.

The plug 20 is spaced apart from the pipe end 12 by the stops 24 at all times thereby allowing the invention blade assembly 40, 70 to be inserted between the plug lid 21 and pipe end 12 facilitating removal of the cap 20 from the pipe 10. The general operation of the tool 30, 60 is manifested by positioning the blade assembly blade opening 46, 76 circumferentially about the plug body portion 22 between the plug lid 21 and pipe end 12. A worker would then grasp the invention handle 31, 61 and pry plug or cap 20 out of and off the sewer pipe end 12.

It is understood that the above-described embodiment is merely illustrative of the application. Other embodiments may be readily devised by those skilled in the art which will embody the principles of the invention and fall within the spirit and scope thereof.

I claim:

1. A tool for removing a sealing cap or plug having a lid from a pipe, comprising:
an elongated handle;
a shaped pry bar blade attached to said elongated handle, said pry bar blade having a semicircular opening formed therein with a radius approximately equal to the radius of the sewer pipe;
wherein said pry blade is fitted about the neck of the sealing device and manipulated by means of said handle to pry the sealing device from the sewer pipe.

2. The tool as recited in claim 1, wherein:
said pry bar blade has an upright vertical orientation, and has a top, two sides, a bottom, a front and a rear, said blade having a generally flat, rectangular, plate-like body with a substantial, semicircular opening formed therein with the diameter of the widest portion of the opening coinciding centrally with the blade assembly bottom, said opening having an inwardly directed, sharpened beveled edge formed about the opening perimeter.

3. The tool as recited in claim 2, further comprising:
a flat flange fixedly attached to said blade top, said flange lying in a plane perpendicular to the plane of the blade assembly, said flange having a hollow, cylindrical collar centrally and fixedly attached thereto, said collar protruding away from the said flange.

4. The tool as recited in claim 3, wherein:
said elongated handle has a blade end and an opposite free end, said blade end adapted to being inserted into and attached to said cylindrical collar.

5. The tool as recited in claim 4, wherein:
said collar has a central, longitudinal axis positioned perpendicularly to the plane of the flange.

6. The tool as recited in claim 4, wherein:
said collar has a central, longitudinal axis angled away from the plane of the flange.

7. A tool for removing a sealing cap or plug having a lid from a pipe, comprising:
an elongated handle;
a shaped prying blade attached to said elongated handle, said pry bar blade having a generally flat, crescent-shaped, plate-like body with a semicircular opening formed therein with a radius approximately equal to the radius of the sewer pipe;
wherein said pry blade is fitted about the neck of the sealing device and manipulated by means of said handle to pry the sealing device from the sewer pipe.

8. The tool as recited in claim 7, wherein:
said pry bar blade has an upright vertical orientation, and has a top, two sides, a bottom, a front and a rear, said semicircular opening diameter of the widest portion of the opening coinciding centrally with the blade assembly bottom, said opening having an inwardly directed, sharpened beveled edge formed about the opening perimeter.

9. The tool as recited in claim 8, further comprising:
a flat-bar flange fixedly attached to said blade top, said flange lying in a plane perpendicular to the plane of the blade, said flange having a hollow, cylindrical collar welded to its center, said collar protruding perpendicularly away from the blade top and flange.

10. The tool as recited in claim 9, wherein:
said elongated handle has a blade end and an opposite free end, said blade end adapted to being inserted into and attached to said cylindrical collar.

11. The tool as recited in claim 10, wherein:
said collar has a central, longitudinal axis positioned perpendicularly to the plane of the flange.

12. The tool as recited in claim 10, wherein:
said collar has a central, longitudinal axis angled away from the plane of the flange.
